(19) United States
(12) Patent Application Publication
(10) Pub. No.: US 2026/0051191 A1
(43) Pub. Date: Feb. 19, 2026

(54) METHOD AND APPARATUS FOR EVALUATING THE QUALITY OF MODEL SAMPLES, STORAGE MEDIUM, AND COMPUTING DEVICE

(71) Applicant: Tongfang Knowledge Network Digital Publishing Technology Co., Ltd., Beijing (CN)

(72) Inventors: Qinghui SHI, Beijing (CN); Chong GENG, Beijing (CN); Xiaofei LU, Beijing (CN); Yanhong BI, Beijing (CN); Dejun XUE, Beijing (CN)

(73) Assignee: Tongfang Knowledge Network Digital Publishing Technology Co., Ltd., Beijing (CN)

(21) Appl. No.: 18/903,160

(22) Filed: Oct. 1, 2024

(30) Foreign Application Priority Data
Aug. 13, 2024 (CN) 202411104070.1

(51) Int. Cl. G06V 30/19

(52) U.S. Cl. CPC G06V 30/1916; G06V 30/19093; G06V 30/19173

(57) ABSTRACT

The present disclosure provides a method and an apparatus for evaluating the quality of model samples, a storage medium and a computer device. The method includes: inputting sample data into an AI-generated content detection model to obtain a hit probability of the sample data; matching a content evaluation system based on the attribute information of the sample data; processing the sample data based on the evaluation rule in the content evaluation system to determine a test value of the sample data relative to at least one preset evaluation index; and performing a weighted calculation on the hit probability and the test value based on a target weight corresponding to the hit probability and the preset evaluation criterion, to obtain a quality score of the sample data. This method is capable of filtering data that may mislead model training, and also realizing a high-precision evaluation of the training data.

### CROSS-REFERENCE TO RELATED APPLICATIONS

The application claims priority to Chinese patent application No. 202411104070.1, filed on Aug. 13, 2024, the entire contents of which are incorporated herein by reference.

### TECHNICAL FIELD

The present disclosure relates to the technical field of computer technologies, and in particular, to a method and an apparatus for evaluating the quality of model samples, a storage medium, and a computing device.

### BACKGROUND

In recent years, with the improvement of big data and computing capability, deep learning models have made significant progress in various fields. However, these models typically impose high demands on training data, especially in complex tasks such as natural language processing, image recognition, etc. At present, the training of large-scale models is increasingly dependent on large and high-quality datasets. However, the uneven quality of data becomes a critical factor limiting the improvement of the performance of the model, and low-quality data often leads to problems of the model such as over-fitting, bias and poor generalization.

In the field of training data evaluation, traditional methods often rely on manual labeling or simple statistical metrics, and these methods have problems of strong subjectivity, low efficiency, difficulty in covering all data points, and other related issues.

### SUMMARY

In view of this, the present disclosure provides a method and an apparatus for evaluating the quality of a model sample, a storage medium, and a computing device. By integrating an AI-generated content detection technology with a content evaluation strategy, a comprehensive and precise evaluation of training sample data is implemented.

According to one aspect of the present disclosure, a method for evaluating the quality of model samples is provided, including:
inputting the sample data into an AI-generated content detection model to obtain a hit probability of the sample data;
matching a content evaluation system based on the attribute information of the sample data, wherein the content evaluation system includes at least one preset evaluation index and its evaluation rule of the preset evaluation index;
processing the sample data based on the evaluation rule to determine a test value of the sample data relative to at least one preset evaluation index; and
Applying a weighted calculation to the hit probability and the test value based on a target weight corresponding to the hit probability and the preset evaluation index, to obtain a quality score for the sample data.

Optionally, the method for evaluating the quality of model samples further includes:
training a target large model using the sample data with the quality score greater than a predefined threshold;
inputting test data into the target large model to obtain prediction data;
comparing the prediction data with the ground truth values associated with the test data to determine the accuracy of the target large model;
in a case that the accuracy is less than the accuracy threshold, adjusting the target weight based on the accuracy;
in a case that the accuracy is greater than or equal to the accuracy threshold, outputting the target large model.

Optionally, the method for evaluating the quality of model samples further includes:
in a case that the sample data is of the text type, obtaining pre-stored data whose attributes are within in the same range as those of the sample data, where the quality score of the pre-stored data is greater than a predefined threshold;

Determining a feature similarity between the sample data and the pre-stored data by using a semantic similarity algorithm;
in a case that the feature similarity is greater than a first similarity threshold, cancelling the processing of the sample data based on the evaluation rule, and using the test value of the pre-stored data as the test value of the sample data.

Optionally, the method for evaluating the quality of model samples further includes:
obtaining manually created data of the target theme as positive samples;
inputting the target theme into an artificial intelligence model to obtain AI-produced data of the target theme as negative samples;
dividing the positive and negative samples into a training set and a validation set, wherein the difference in the number of positive samples and negative samples in the training set is less than a predefined threshold;
training a classification model using the training set to obtain a candidate model;
inputting the validation set into the candidate model to obtain a predicted probability for the validation set;
in a case that the predicted probability of the positive samples in the validation set is less than the first preset probability, and the predicted probability of the negative samples in the validation set is greater than a second preset probability, confirming the candidate model as the AI-generated content detection model;
in a case that the predicted probability of the positive samples in the validation set is greater than or equal to the first preset probability, or the predicted probability of the negative samples in the validation set is less than or equal to the second preset probability, sending the positive samples or the negative samples in the validation set to a review node; and
training the candidate model based on target features fed back by the review node, to obtain the AI-generated content detection model.

Optionally, the method for evaluating the quality of model samples further includes:
performing an integrity check on the sample data;
in a case that the input part or the output part of the sample data is missing, deleting the sample data, or supplementing the missing input or output part of the sample data based on the existing input part or the existing output part of the sample data.

Optionally, the attribute information includes at least one of the following: data application scenario, data type, data format, word count, and memory usage;
the preset evaluation criteria includes at least one of the following: grammatical accuracy, lexical diversity, presence of watermarks in images or videos, content richness, content coherence, and noise ratio.

Optionally, the data type of the sample data is text, and the preset evaluation criteria includes content richness. Processing the sample data based on the evaluation rule includes:
performing tokenization on the sample data to identify multiple tokens in the sample data;
determining the semantic similarity between different tokens in the sample data by using a natural language processing(NLP) algorithm;
grouping different tokens with the semantic similarity greater than a second similarity threshold into sets of similar tokens;
counting token frequencies of the similar token sets, the number of the similar token sets, and the total word count of the sample data;
matching a comparison relationship among the token frequency range, the number range and content richness based on the total word count of the sample data;
comparing the token frequencies with the predefined frequency range of the similar token sets, and the number with the number range of the similar token sets, respectively, based on the comparison relationship, to determine the content richness corresponding to the token frequencies of the similar token sets and the number of the similar token sets.

According to another aspect of the present disclosure, an apparatus for evaluating the quality of model samples is provided, including:
a first detection module, configured to input sample data into an AI-generated content detection model to obtain a hit probability of the sample data;
a matching module, configured to match a content evaluation system based on the attribute information of the sample data, wherein the content evaluation system includes at least one preset evaluation criterion and the evaluation rule of the preset evaluation criterion;
a second detection module, configured to process the sample data based on the evaluation rule to determine a test value of the sample data relative to the at least one preset evaluation criterion; and
an evaluation module, configured to compute a weighted score for the hit probability and the test value based on a target weight corresponding to the hit probability and the preset evaluation metric to obtain a quality score of the sample data.

Optionally, the apparatus for evaluating the quality of model samples further includes:
a first training module, configured to train a target large model based on the sample data with the quality score greater than the score threshold;
a test module, configured to input test data into the target large model to obtain prediction data; and to compare the predictions with the ground truth labels associated with the test data to determine the accuracy of the target large model;
an update module, configured to adjust the target weight based on the accuracy in a case that the accuracy is less than the accuracy threshold,
wherein the first training module is further configured to output the target large model in a case that the accuracy is greater than or equal to the accuracy threshold.

Optionally, the second detection module is further configured to: in a case that the sample data is of text type, obtain pre-stored data whose attribute information is in the same range as that of the sample data, where the quality score of the pre-stored data is greater than a score threshold;
determine a feature similarity between the sample data and the pre-stored data by using a text similarity algorithm;
in a case that the feature similarity is greater than a first similarity threshold, cancel the processing of the sample data based on the evaluation rule, and take the test value of the pre-stored data as the test value of the sample data.

Optionally, the apparatus for evaluating the quality of model samples further includes:
an obtaining module, configured to: obtain manually created data of a target theme as positive samples; and to input the target theme into an artificial intelligence model to obtain AI-generated data of the target theme as negative samples; and to divide the positive samples and the negative samples into a training set and a validation set, wherein the difference in the number of positive samples and the negative samples in the training set is less than a predefined threshold;
a second training module, configured to: train a classification model using the training set to obtain a candidate model; and to input the validation dataset into the candidate model to obtain a predicted probability of the validation set; and in a case that the predicted probability of the positive sample in the validation set is less than a first preset probability, and the predicted probability of the negative sample in the validation set is greater than a second preset probability, to confirm the candidate model as the AI-generated content detection model;
a review module, configured to, in a case that the predicted probability of the positive samples in the validation set is greater than or equal to the first preset probability, or the predicted probability of the negative samples in the validation set is less than or equal to the second preset probability, send the positive samples or the negative samples in the validation set to a review node,
wherein the second training module is further configured to train the candidate model based on target features fed back by the review node, to obtain the AI-generated content detection model.

Optionally, the apparatus for evaluating the quality of model samples further includes:
an integrity check module, configured to perform an integrity check on the sample data; and
in a case that the input part or the output part of the sample data is missing, delete the sample data, or supplement the missing input part or the missing output part of the sample data based on the existing input part or the existing output part of the sample data.

Optionally, the attribute information includes at least one of: data application scenario, data type, data format, word count, and memory usage;
the preset evaluation metrics include at least one of: grammar accuracy, vocabulary diversity, presence of watermarks in an images or videos, content richness, content coherence, and noise ratio.

Optionally, the second detection module is specifically configured to perform tokenization on the sample data to identify multiple tokens in the sample data;
to determine the semantic similarity between different tokens in the sample data by using a natural language processing (NLP) algorithm;
to group different tokens with the semantic similarity greater than a second similarity threshold into similar token sets;
to count token frequencies of the similar token sets, the number of the similar token sets, and the number of words of the sample data;
to match a comparison relationship among the token frequency range, the number range and content richness based on the number of words of the sample data; and
to compare the token frequencies with the token frequency range of the similar token sets, and the number with the number range of the similar token sets, respectively, based on the comparison relationship, to determine the content richness corresponding to the token frequencies of the similar vocabulary sets and the number of the similar token sets.

According to another aspect of the present disclosure, a readable storage medium having programs or instructions stored thereon is provided, wherein the programs or instructions, when executed by a processor, perform the steps of the aforementioned method for evaluating the quality of model samples.

According to still another aspect of the present disclosure, a computer device is provided, comprising a storage medium, a processor and a computer program stored on the storage medium and executable by the processor, wherein the processor, when executing the program, performs the steps of the aforementioned method for evaluating the quality of model samples.

By means of the described technical solutions, the probability of sample data being AI-generated is determined by the pre-trained artificial intelligence generated content detection model, allowing for the screening of samples with high authenticity and low AI generated suspicion. At the same time, the attribute information is used to match at least one preset evaluation metric suitable for the sample data and its corresponding evaluation rule. The sample data are accordingly tested in accordance with the evaluation rule with respect to different preset evaluation metrics, and a test value of the sample data relative to at least one preset evaluation metric is obtained. Finally, based on a target weight corresponding to the hit probability and the preset evaluation metric, the weights of the hit probability and the test value are calculated in order to complete the quality scoring of the sample data. On the one hand, by combining an advanced artificial intelligence generated content (AIGC) detection technology and a content innovation evaluation strategy, a comprehensive and accurate evaluation of the training data is achieved, which not only effectively filters out those AI-generated data that may mislead the model training, but also significantly improves the purity and credibility of the sample dataset, which enhances the authenticity and reliability of the training data and lays a solid foundation for the subsequent model training. On the other hand, the preset evaluation metrics and the evaluation rules are adjusted and matched dynamically through the attribute information of the sample data, providing high flexibility, realizing multidimensional and high-precision evaluation of the training data, and covering key dimensions, such as data integrity, accuracy, diversity, and innovativeness. The present disclosure satisfies different task requirements, and improves the generalization capability of the model trained based on the sample data and its ability to adapt to unknown data. The effort of redeveloping the model after introducing a new evaluation rule is eliminated, and the operational cost and difficulty of data quality assessment are reduced.

The above description is merely an overview of the technical solutions of the present disclosure. Embodiments of the present disclosure are described hereinafter in order for a clear understanding of the technical solutions of the present disclosure so as to implement the technical solutions based on the specification, and further for a clear and easy understanding of the above and other objectives, features and advantages of the present disclosure.

### BRIEF DESCRIPTION OF DRAWINGS

The accompanying drawings described herein are used for providing a further understanding of the present disclosure, and form a part of the present disclosure. Exemplary embodiments of the present disclosure and descriptions thereof are for explaining the present disclosure without imposing any inappropriate limitation to the present disclosure. In the drawings:

FIG. 1 shows a first schematic flowchart of a method for evaluating the quality of model samples according to an embodiment of the present disclosure;

FIG. 2 shows a second schematic flowchart of a method for evaluating the quality of model samples according to an embodiment of the present disclosure;

FIG. 3 shows a third schematic flowchart of a method for evaluating the quality of model samples according to an embodiment of the present disclosure; and

FIG. 4 shows a structural block diagram of an apparatus for evaluating the quality of model samples according to an embodiment of the present disclosure.

### DETAILED DESCRIPTION OF THE EMBODIMENTS

The present disclosure is described in detail below with reference to the accompanying drawings and embodiments. It should be noted that the embodiments of the present application and features thereof may be combined with each other without conflict.

Embodiments of the present application are described in detail below. Examples of the embodiments are shown in the drawings. Throughout the drawings, the same or similar reference signs denote the same or similar elements or elements having the same or similar functions. The embodiments described below, along with the figures, are for illustrative purposes only and are intended to provide a better understanding of the present disclosure, and shall not be construed as a limitation to the present disclosure.

Those skilled in the art can understand that, unless specifically stated, a singular form with “a”, “an”, “said” and “the” used herein may include a plural form as well. It should be further understood that the expression “comprise/include” used in the specification of the present disclosure indicates the presence of a the stated features, integers, steps, operations, elements and/or components, and does not exclude the presence or addition of one or more other features, integers, steps, operations, elements, components, and/or groups thereof. It should be understood that when an element is referred to as being “connected to” or “connected with” another element, the element may be directly connected to or connected with the another element, or there may be an intermediate element there between. Additionally, the “connected to” or “connected with” used herein may include a wireless connection or wireless coupling. The term “and/or” used herein includes all or any unit or all combinations of one or more associated listed items.

Illustrative embodiments of the present disclosure will now be described in detail with reference to the drawings. These exemplary embodiments may be implemented in various forms, and should not be construed as being limited to those illustrated herein. It should be understood that these embodiments are aimed at making the present disclosure thorough and complete, and conveying a inventive concept thereof to those skilled in the art.

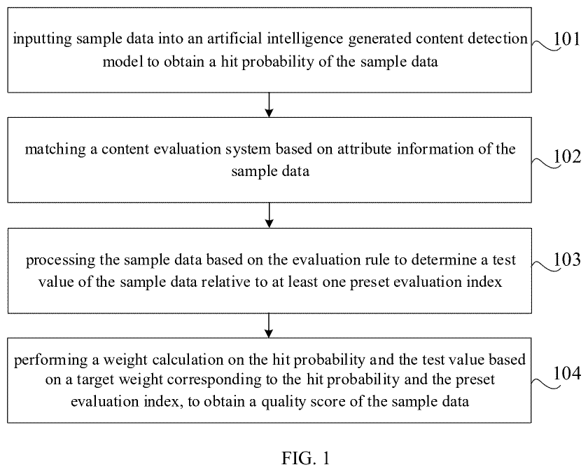

In this embodiment, a method for evaluating the quality of model samples is provided, as shown in FIG. 1, the method includes:
step 101, inputting sample data into an AI-generated content detection model to obtain a hit probability of the sample data;
wherein the sample data includes text data, image data, video data, voice data, and the like, which is not limited in the embodiment of the present disclosure. The greater the hit probability, the higher the likelihood that sample data is generated by AI.

Specifically, the Artificial Intelligence Generated Content (AIGC) detection model is used to be able to learn and capture subtle differences between AI-generated data and data generated by human creativity, and derive hit probability that the data was generated by an AI. The artificial intelligence generated content detection model may be obtained by training a classification model by utilizing large labeled datasets (including AI generated and manually created data).

Illustratively, the AI-generated hit probability of text A detected by the AIGC is 0.001, indicating that the text is highly likely written by a human, and therefore may be assigned a higher content innovation value. The AI-generated hit probability of text B detected by the AIGC is 0.957, indicating that the text is likely generated by an AI. Therefore, the content innovation value should be reduced accordingly.

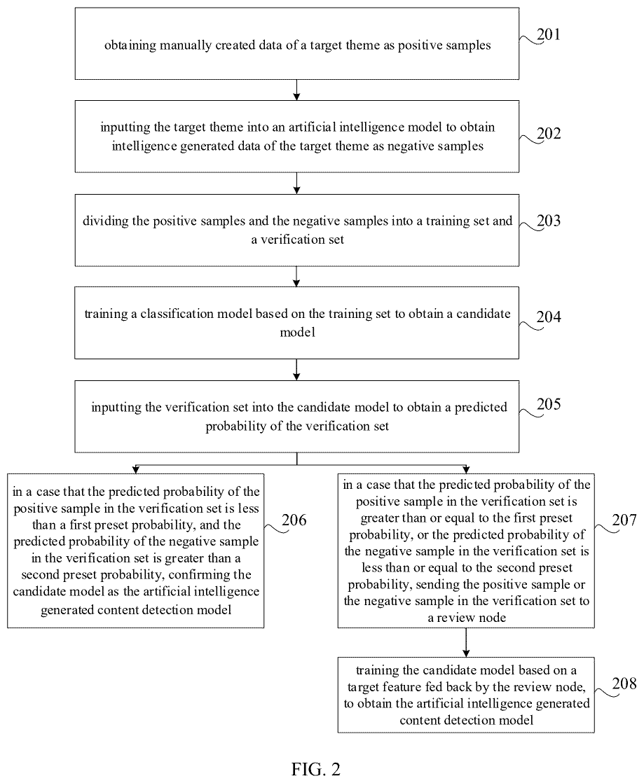

In a practical application scenario, as shown in FIG. 2, prior to step 101, the method for evaluating the quality of model samples further comprises:
step 201, obtaining manually created data of a target theme as positive samples; and
step 202, inputting the target theme into an artificial intelligence model to obtain AI-generated data of the target theme as negative samples;
it should be understood that the data generated by the artificial intelligence model is simpler compare to manually created data. Taking text as an example, the negative samples generated by the artificial intelligence model have a fixed grammatical structure and uniform wording, while users have different writing habits as well as expressive styles, and there are complex variability and multiple complex grammars in user-created articles,
step 203, dividing the positive samples and the negative samples into a training set and a validation set;
wherein the training set is used for training the classification model, and the validation set is used for verifying the quality and the classification effect of the trained classification model. The total number of the collected positive/negative samples is usually divided into a training set and a validation set according to a predefined ratio (for example, a ratio of 8:2).

It is noteworthy that the difference in quantity between the positive samples and the negative samples in the training set or the validation set is less than a certain threshold, so that the number of the positive samples and the negative samples used in the training model and the validation model are equivalent, thus balancing the results of the model training or validation will not be tilted to a certain side, and effectively reducing the degree of sample imbalance, which optimizes the quality of the model, and contributing to improved classification accuracy.

The method for evaluating the quality of model samples further includes: step 204, training a classification model based on the training set to obtain a candidate model;
in this embodiment, a large number of labeled AI-generated negative samples and manually created positive samples are used to train a classification model so that the classification model is able to learn and capture differences in features between AI generation and human creation, such as sentence structure, semantic coherence, video length, diversity, etc. This enables the trained model to better determine the likelihood that the sample data was generated by the AI,
step 205, inputting the validation set into the candidate model to obtain a predicted probability of the validation set;
wherein the greater the predicted probability, the higher the likelihood that the sample in the validation set is generated by AI,
step 206, in a case that the predicted probability of the positive samples in the validation set is less than a first preset probability, and the predicted probability of the negative samples in the validation set is greater than a second preset probability, confirming the candidate model as the artificial intelligence generated content detection model;
step 207, in a case that the predicted probability of the positive sample in the validation set is greater than or equal to the first preset probability, or the predicted probability of the negative sample in the validation set is less than or equal to the second preset probability, sending the positive samples or the negative samples in the validation set to a review node;
wherein the first preset probability is less than or equal to the second preset probability,
step 208, training the candidate model based on the target features fed back by the review node, to obtain the artificial intelligence generated content detection model.

In this embodiment, the validation set is input into the candidate model, to obtain the predicted probability of whether the samples in the validation set is generated by AI. The probability of determining it to be AI-generated should be small for positive samples and large for negative samples. By comparing the predicted probability and the first preset probability for the positive samples, and the predicted probability and the second preset probability for the negative samples, the accuracy of the candidate model's predictions is evaluated. In a case that the predicted probability of the positive sample in the validation set is less than the first preset probability, and the predicted probability of the negative sample in the verification set is greater than the second preset probability, which indicates the predicted probabilities of the positive samples and the negative samples align with the sample labels, and the model's predictions are more accurate, the candidate model is outputted as the artificial intelligence generated content detection model. Otherwise, in a case that the predicted probability of the positive sample in the validation set is greater than or equal to the first preset probability, or the predicted probability of the negative sample in the validation set is less than or equal to the second preset probability, which indicates that the model's predictions are inaccurate, and the system sends the positive samples or the negative samples with abnormal predictions in the validation set to a review node. Managers to which the review node belongs manually review the positive samples or the negative samples to find target features between manual creation and artificial intelligent creation which are not easily perceived in the positive samples or the negative samples with abnormal prediction. The system then fine-trains the candidate model again according to the target features fed back by the review nodes to form the artificial intelligence generated content detection model. Not only the prediction capability of the model on positive samples and negative samples can be continuously optimized, improving the performance and the expansibility of the artificial intelligence generated content detection model, but also the utilization efficiency of computing resources can be effectively optimized by the verification processing of the positive samples and negative samples in the validation set, avoiding the waste of the resources and unnecessary computing overhead.

In an embodiment, before step 101, the method for evaluating the quality of model samples further includes: performing an integrity check on the sample data; and in a case that the input part or the output part of the sample data is missing, deleting the sample data, or supplementing the missed input part or the missed output part of the sample data based on the existing input part or the existing output part of the sample data.

In this embodiment, the missing data is not processed, which may cause instability in model training and affect the generalization capability of the model. Therefore, integrity checks can be performed to find out in a case that there is any missing data or labels in the sample data. And delete or supplement the missed data. This improves the overall quality of the sample data, ensures that the data used in model training is complete and accurate, reduces the risks of over-fitting and under-fitting in model training, and helps to improve the reliability of model prediction. Meanwhile, it can also simplify the data quality evaluation process and improve the efficiency of data processing.

Further, in order to improve the efficiency of subsequent data screening and model training, the system may also convert sample data from different sources into a uniform format to ensure data consistency and comparability.

The method includes: step 102, matching a content evaluation system based on the attribute information of the sample data;
wherein the content evaluation system includes at least one preset evaluation metric and the evaluation rules of the preset evaluation metric.

In practical application scenarios, the attribute information includes at least one of the following: data application scenario, data type, data format, word count, and memory usage. The preset evaluation metrics include at least one of: grammar correctness, vocabulary diversity, presence of watermarks in images or videos, content richness, content coherence and noise ratio. For example, for sample data of text type, the suitable preset evaluation metrics are matched to grammar correctness, vocabulary diversity, content richness and content coherence; for sample data of video type, the suitable preset evaluation indexes are matched to content richness, content coherence, presence of watermarks in images or videos and noise ratio. For text data with a large number of words, the detection of content richness can be omitted; compared with voice data generated from audio recording, the detection of noise ratio can be omitted for voice data synthesized through computer translation.

It should be noted that, for the same preset evaluation metric, the evaluation rules of the preset evaluation index obtained through matching different attribute information may be the same or different. For example, with respect to the detection of content coherence, text data may be assessed by detecting semantic coherence, and video data may be detected by the order of video timestamps.

The method includes: step 103, processing the sample data based on the evaluation rule to determine a test value of the sample data relative to at least one preset evaluation index.

In this embodiment, the preset evaluation metrics and the evaluation rules are adjusted and matched dynamically through the attribute information of the sample data, which has a high degree of flexibility, realizes multidimensional and high-precision evaluation of the training data, and covers key aspects, such as data integrity, accuracy, diversity, and innovativeness. The present disclosure satisfies different task requirements. The effort of redeveloping the model after introducing a new evaluation rule is saved, and the operational cost and operational complexity of data quality assessment are reduced.

Illustratively, in a case that the data type of the sample data is text, and the preset evaluation index includes content richness, the process of handling the sample data based on the evaluation rule in step 103 includes: performing tokenization on the sample data to extract multiple tokens; determining a semantic similarity between different tokens in the sample data by using a natural language processing algorithm; grouping different tokens with the semantic similarity greater than a second similarity threshold into similar token sets; calculating the token frequencies of the similar token sets, the total number of the similar token sets and the total word count of the sample data; matching a comparison relationship among the token frequency range, the number range and content richness based on the number of words of the sample data; and comparing the token frequencies with the token frequency range of the similar token sets, and the number with the number range of the similar token sets, respectively, based on the comparison relationship, to determine the content richness corresponding to the token frequencies of the similar token sets and the number of the similar token sets.

In this embodiment, sample data of a text type is divided into multiple tokens using a word segmentation tool (e.g., jieba Chinese word segmentation library). These tokens are then converted into word vectors by a Natural Language processing (NLP) algorithm, and semantic similarities between these word vectors are compared. When the semantic similarity of any two words is greater than the second similarity threshold, the token may be determined as a near-synonym, and the semantically similar tokens are aggregated to form a similar token set. The token frequency of all the words in the similar vocabulary set, the number of different similar token sets and the word count of the sample data as a whole are counted in terms of similar token sets. The word count of the sample data is used to dynamically match the comparison relationship among the token frequency range, the number range and content richness, to avoid the misjudgment of longer texts due to the higher token frequency of more vocabulary used in the test using the unified standard. Finally, the corresponding relationship is used as the basis to determine the content richness corresponding to the token frequency and the number of similar token sets, so as to automate the completion of accurate content richness evaluation.

Similarly, the detection of the vocabulary diversity may be determined by the number of different similar token sets or the number of different tokens in the same similar token set. A higher number of different similar token sets indicates the use of a broader range of meanings in the text, the vocabulary diversity is greater. The more the number of different tokens in the same similar token set is, indicating the more synonyms and linguistic forms are used in the text, the higher the token diversity is.

In a case that the data type of the sample data is text, and the preset evaluation index includes grammar correctness, the processing the sample data based on the evaluation rule in step 103 includes: segmenting the sample data into multiple sentences based on punctuation to obtain a plurality of sentences; performing grammar analysis processing on a plurality of sentences by using a natural language processing algorithm to determine grammar structure of the sentences; and in a case that the grammar structure of the sentence is the same as the standard grammar structure, determining that the grammar of the sentence is correct; in a case that the grammar structure of the sentence is different from the standard grammar structure, determining that the grammar of the sentence is incorrect.

In this embodiment, the grammar analysis is conducted using NLP libraries (e.g., spaCy, NLTK, Stanford NLP, etc.). The grammar structure of the text may be identified through methods such as dependency parsing and syntax tree generation to detect potential grammatical errors.

In a case that the data type of the sample data is image or video, and the preset evaluation index includes detecting the presence of watermarks in images or videos, the processing of the sample data based on the evaluation rule in step 103 includes: inputting the sample data into a watermark detection model to obtain a detection result of the sample data containing a watermark, wherein the watermark detection model is trained by using historical images, videos and their corresponding watermark labels.

In this embodiment, by means of the watermark detection model, it may be detected whether sample data of image or video type contains a watermark. In a case that the sample data contains a watermark, it can be determined that the probability that the sample data generated by AI is high.

In an embodiment, before step 103, the method for evaluating the quality of the model sample further includes: in a case that the data type of the sample data is text, obtaining pre-stored data whose attribute information is in the same range as the attribute information of the sample data; determining the feature similarity between the sample data and the pre-stored data by using a text similarity algorithm; and in a case that the feature similarity is greater than a first similarity threshold, cancelling the processing of the sample data based on the evaluation rule, and using the test value of the pre-stored data as the test value of the sample data.

Wherein the quality score of the pre-stored data is greater than a score threshold. The score threshold and the first similarity threshold can be reasonably set according to detection precision and experience.

In this embodiment, for the sample data of the text type, the attribute information of the sample data to be detected currently is compared with that of the screened high-quality pre-stored data. In a case that the attribute information of the sample data and the high-quality pre-stored data is in the same range, the sample data and the pre-stored data are data of the same category and can be referred to each other. And further a feature similarity between the sample data and the pre-stored data is calculated by a text similarity algorithm. In a case that the feature similarity is greater than a first similarity threshold, suggesting that the semantic, syntactic, and other characteristics of the sample and pre-stored data are similar, the processing of the sample data based on the evaluation rule is canceled, and the test value of the pre-stored data is directly adopted as the test value of the sample data. Therefore, repeated content evaluation of the same type of data with high similarity is omitted, which further reduces the waste of resources and unnecessary computing overhead, significantly improve the efficiency of the system for evaluating the quality of the model sample, and helps to realize the function of batch data screening.

Further, in a case that the feature similarity is less than a third similarity threshold, the sample data of which the feature similarity is less than the third similarity threshold is deleted. Therefore, low-value or abnormal sample data is identified by comparing it with high-quality data, and the low-value or abnormal sample data is filtered out targeted to improve the quality of the sample data. Wherein the third similarity threshold is much less than the first similarity threshold.

Specifically, the text similarity algorithm may be cosine similarity algorithm, Jaccard similarity algorithm, Manhattan distance algorithm, or the like, which is not limited in the embodiment.

The method further includes: step 104, performing a weighted calculation on the hit probability and the test value based on a target weight corresponding to the hit probability and the preset evaluation index, to obtain a quality score of the sample data.

According to the method for evaluating the quality of a model sample provided in the embodiments of the present disclosure, the probability of sample data being AI generated is determined by the pre-trained artificial intelligence generated content detection model, so as to screen samples with high authenticity and low AI generated suspicion. At the same time, the attribute information is used to match at least one preset evaluation index suitable for the sample data and its corresponding evaluation rule. The sample data are accordingly tested in accordance with the evaluation rule with respect to different preset evaluation indexes, and a test value of the sample data relative to at least one preset evaluation index is obtained. Finally, based on a target weight corresponding to the hit probability and the preset evaluation index, the weights of the hit probability and the test value are calculated in order to complete the quality scoring of the sample data. On the one hand, by integrating an advanced artificial intelligence generated content detection technology and a content innovation evaluation strategy, a comprehensive and accurate evaluation of the training data is realized, which not only effectively filters out those AI-generated data that may mislead model training, but also significantly improves the purity and credibility of the sample dataset, which enhances the authenticity and reliability of the sample data for training needs, and lays a solid foundation for the subsequent model training, so that a better prediction or classification effect on specific task is achieved by using high-quality sample data to train the model. On the other hand, the preset evaluation indexes and the evaluation rules are adjusted and matched dynamically through the attribute information of the sample data, which has a high degree of flexibility, realizes multidimensional and high-precision evaluation of the training data, and covers key aspects, such as data integrity, accuracy, diversity, and innovativeness. The present disclosure satisfies different task requirements, and improves the generalization capability of the model trained based on the sample data and its ability to adapt to unknown data. The effort of redeveloping the model after introducing new evaluation rules is saved, and the operational cost and difficulty of data quality assessment are reduced.

It can be understood that the quality report of the sample data is generated based on the test value of the sample data under each evaluation index and AI-generated hit probability. The user can obtain the quality of the sample data intuitively through the quality report, and perceive the sample quality problems at different stages, which plays a certain role in guiding the improvement of data quality. In addition, the user can further continuously adjust and optimize parameters and algorithms of the evaluation system according to data problems indicated by the quality report and influences thereof on the performance of the model, and introduce new evaluation dimensions and indexes to more comprehensively evaluate the quality of the sample data.

In an actual application scenarios, a target weight may be determined according to the prediction results of the target large model, wherein the target large model is trained on training sample data with a quality score greater than the score threshold. In this way, a close linkage between data filtering and model training is ensured by using a closed-loop feedback and adjustment mechanism, which not only improves the overall performance of the trained model, but also enhances the adaptability and robustness of the data filtering mechanism.

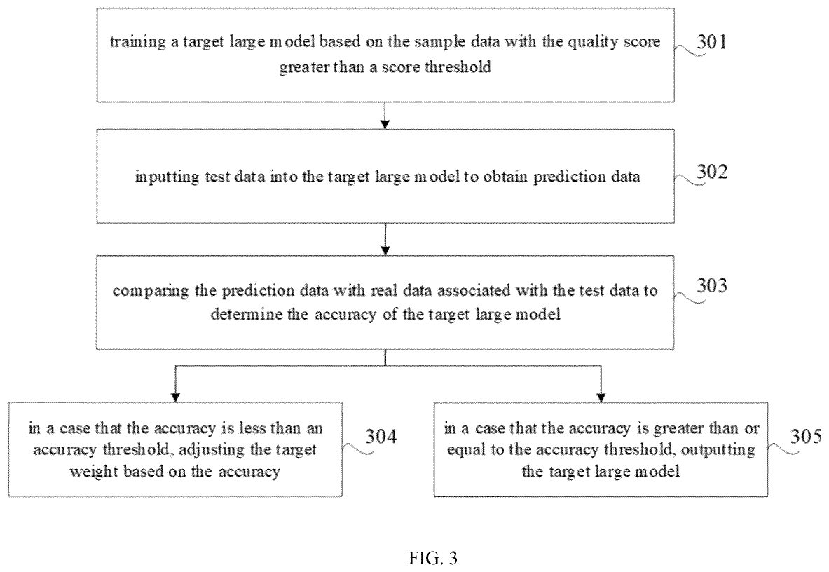

Specifically, as shown in FIG. 3, the method for evaluating the quality of a model sample further includes:
step 301, training a target large model based on the sample data with the quality score greater than the score threshold;
step 302, inputting test data into the target large model to obtain prediction data;
step 303, comparing the prediction data with real data associated with the test data to determine the accuracy of the target large model;
it can be understood that, in a case that the target large model is also a generative model, the artificial intelligence generated content detection model may also be used to detect the prediction data, quantify its innovation, logic, and difference from the sample data by whether the prediction data is AI-generated or not, and determine the accuracy of the target large model.

The method further includes: step 304, in a case that the accuracy is less than an accuracy threshold, adjusting the target weight based on the accuracy; and
step 305, in a case that the accuracy is greater than or equal to the accuracy threshold, outputting the target large model.

Wherein the accuracy threshold can be set reasonably according to the training accuracy required by the user.

In this embodiment, when the quality score of the sample data is detected to be greater than the score threshold, indicating that the sample data has relatively high quality, the sample data is used to train the target large model. The test data is inputted into the trained target large model to generate prediction data. The accuracy of the trained target large model is determined by comparing the differences between the predictions and the ground truth associated with the test data. In a case that the accuracy of the large target model is less than an accuracy threshold, it may be determined that there is an abnormality in data filtering, for example, the standard is too strict or too wide, resulting in an unqualified effect of prediction or classification of the large target model. In this case, the accuracy is used to adjust the target weights of hit probability and different preset evaluation indexes when screening high-quality sample data. Thus, the rules of the data screening mechanism are optimized, so that the data screening mechanism can constantly adapt to new data requirements, so as to more comprehensively evaluate the quality of the sample data, enhancing the adaptability and robustness of the data filtering mechanism.

It should be noted that, serial numbers of the steps in the foregoing embodiments do not refer to a sequence according to which the steps are performed. The sequence according to which the steps are performed is determined by functions and internal logic thereof, and should not constitute any restrictions on the implementation process of the embodiments of the present disclosure.

The method for evaluating the quality of model samples provided in the embodiment of the present disclosure may be applied in a terminal, may be applied in a server, or may also be software running in a terminal or server. In some embodiments, the terminal may be a smartphone, a tablet computer, a notebook computer, a desktop computer, and the like. The server may be an independent physical server, or may be a server cluster including multiple physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The software may be an application or the like that implements a method for evaluating the quality of a model sample, but the method is not limited to the above forms.

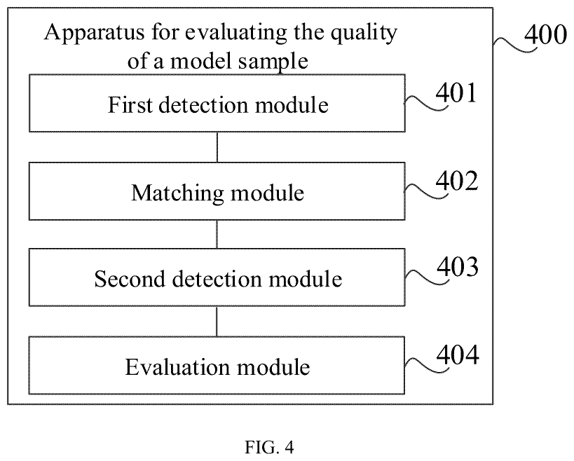

Further, as shown in FIG. 4, as a specific implementation of the foregoing method for evaluating the quality of a model sample, an embodiment of the present disclosure provides an apparatus for evaluating the quality of a model sample 400. The apparatus for evaluating the quality of a model sample 400 includes: a first detection module 401, a matching module 402, a second detection module 403, and an evaluation module 404.

Wherein the first detection module 401 is configured to input sample data into an artificial intelligence generated content detection model to obtain a hit probability of the sample data;
the matching module 402 is configured to match a content evaluation system based on attribute information of the sample data, wherein the content evaluation system includes at least one preset evaluation index and an evaluation rule of the preset evaluation index;
the second detection module 403 is configured to process the sample data based on the evaluation rule to determine a test value of the sample data relative to the at least one preset evaluation index; and
the evaluation module 404 is configured to calculate weighted values for the hit probability and the test value based on a target weight corresponding to the hit probability and the preset evaluation index to obtain a quality score of the sample data.

In this embodiment, the probability of sample data being AI generated is determined by the pre-trained artificial intelligence generated content detection model, so as to filter samples with high authenticity and low AI generated suspicion. At the same time, the attribute information is used to match at least one preset evaluation index suitable for the sample data and the corresponding evaluation rules. The sample data is accordingly tested in accordance with the evaluation rule with respect to different preset evaluation indexes, and a test value of the sample data relative to the at least one preset evaluation index is obtained. Finally, the quality scoring of the sample data is completed by performing weighted calculations on the hit probability and test value, the weights of the hit probability and the test value are calculated in order to complete the quality scoring of the sample data. On one hand, by combining an advanced artificial intelligence generated content detection technology and a content innovation evaluation strategy, a comprehensive and accurate assessment of the training data is realized, which not only effectively filters out those AI-generated data that may mislead the model training, but also significantly improves the purity and credibility of the sample dataset, which enhances the authenticity and reliability of the training data and lays a solid foundation for the subsequent model training. On the other hand, the preset evaluation indexes and the evaluation rules are adjusted and matched dynamically through the attribute information of the sample data, which has a high degree of flexibility, realizes multidimensional and high-precision evaluation of the training data, and covers key aspects, such as data integrity, accuracy, diversity, and innovativeness. The present disclosure satisfies different task requirements, and improves the generalization capability of the model trained based on the sample data and its ability to adapt to unknown data. The effort of redeveloping the model after introducing a new evaluation rule is saved, and the operational cost and difficulty of data quality assessment are reduced.

Further, the apparatus for evaluating the quality of a model sample 400 further includes: a first training module (not shown in the figure), a test module (not shown in the figure), and an update module (not shown in the figure).

Wherein the first training module is configured to train a target large model based on the sample data with the quality score greater than the score threshold;
the testing module is configured to input test data into the target large model to obtain prediction data; and to compare the predictions with the ground truth associated with the test data to determine the accuracy of the target large model; and
the update module is configured to adjust the target weight based on the accuracy in a case that the accuracy is less than an accuracy threshold.

The first training module is further configured to output the target large model when the accuracy is greater than or equal to the specified accuracy threshold.

Further, the second detection module 403 is further configured to handle cases where the data type of the sample data is a text, obtain pre-stored data whose attribute information is in the same range as that of the sample data, wherein the quality score of the pre-stored data is greater than a defined score threshold; determine a feature similarity between the sample data and the pre-stored data by using a text similarity algorithm; in a case that the feature similarity is greater than a first similarity threshold, cancel the processing of the sample data based on the evaluation rule, and the test value of the pre-stored data is used as the test value for the sample data.

Further, the apparatus for evaluating the quality of model samples 400 further includes: an obtaining module (not shown in the figure), a second training module (not shown in the figure), and a review module (not shown in the figure).

Wherein the obtaining module is configured to: obtain manually created data of a target theme as positive samples; and to input the target theme into an artificial intelligence model to generate AI-produced data as negative samples; and to divide the positive samples and the negative samples into a training set and a validation set, wherein the numerical difference between the positive samples and the negative samples in the training set is below a specified threshold;
the second training module is configured to train a classification model using the training set to obtain a candidate model; and to input the validation set into the candidate model to obtain the predicted probabilities of the validation set; and in a case that the predicted probability of the positive samples in the validation set is less than a first preset probability, and the predicted probability of the negative samples in the validation set is greater than a second preset probability, to confirm the candidate model as the artificial intelligence generated content detection model;
the review module is configured to, in a case that the predicted probability of the positive samples in the validation set is greater than or equal to the first preset probability, or the predicted probability of the negative samples in the validation set is less than or equal to the second preset probability, send the positive samples or the negative samples in the validation set to a review node; and
the second training module is further configured to train the candidate model based on target features fed back by the review node, to obtain the artificial intelligence generated content detection model.

Further, the apparatus for evaluating the quality of model samples 400 further includes: an integrity check module (not shown in the Figure).

Wherein the integrity check module is configured to: perform an integrity check on the sample data; and in a case that the input part or the output part of the sample data is missing, delete the sample data, or supplement the missing input part or the missing output part of the sample data based on the existing input part or the existing output part of the sample data.

Further, the attribute information includes at least one of the following: data application scenario, data type, data format, word count, and memory usage; the preset evaluation index includes at least one of: grammar correctness, vocabulary diversity, presence of watermarks in images or videos, content richness, content coherence, and noise ratio.

Further, the second detection module 403 is specifically configured to perform tokenization on the sample data to identify multiple tokens in the sample data, to determine a semantic similarity between different tokens in the sample data by using a natural language processing algorithm; to form different tokens with the semantic similarity greater than a second similarity threshold into similar token sets; to count token frequencies of the similar token sets, the number of the similar token sets, and the total word count of the sample data; to match a comparison relationship among the token frequency range, the number range and content richness based on the number of words of the sample data; and to compare the token frequencies with the token frequency range of the similar token sets, and the number with the number range of the similar token sets, respectively, based on the comparison relationship, to determine the content richness corresponding to the token frequencies of the similar token sets and the number of the similar token sets.

For details about the apparatus for evaluating the quality of a model sample, reference can be made to the previously described method for evaluating the quality of a model sample, which will not be repeated here. Modules of the apparatus for evaluating the quality of a model sample may be implemented, in whole or in part, by software, hardware and a combination of both. The modules may be embedded in or independent of a processor of a computer device in the form of hardware, or may be stored in a memory of the computer device in the form of software, for the processor to invoke and execute operations corresponding to the modules.

Based on the described method as shown in FIG. 1 to FIG. 3, correspondingly, the embodiments of the present disclosure also provide a readable storage medium, on which computer programs are stored, wherein the programs, when executed by a processor, perform the method for evaluating the quality of a model sample as shown in FIG. 1-FIG. 3 is realized.

Based on such understanding, the technical solutions of the present disclosure may be implemented in a form of a software product. The software product may be stored on a non-volatile storage medium (which may be a CD-ROM, a USB flash drive, a removable hard disk, or the like), including multiple instructions for instructing a computing device (which may be a personal computer, a server, a network device, or the like) to execute the method described in each implementation scenario of the present disclosure.

Based on the method as shown in FIG. 1 to FIG. 3 and the virtual apparatus embodiment shown in FIG. 4, in order to achieve the above objectives, a computer device is provided according to an embodiment of the present disclosure. The computer device may specifically be a personal computer, a server, a network device, and the like. The computer device comprises a storage medium and a processor. Wherein the storage medium is configured to store computer programs, and the processor is configured to execute the computer programs to perform the method for evaluating the quality of model samples as shown in FIG. 1 to FIG. 3.

Optionally, the computer device may further include a user interface, a network interface, a camera, a radio frequency (RF) circuit, a sensor, an audio circuit, a WI-FI module, and the like. The user interface may consist of a display, an input unit such as a keyboard, and the like. Optionally, the user interface may further include a USB port, a card reader interface, and the like. The network interface may optionally include standard wired interfaces, wireless interfaces (e.g., Bluetooth interface, WI-FI interface), etc.

Those skilled in the art should understand that, the structure of the computer device provided according to the embodiment does not constitute a limitation to the computer device. The computer device may include more or fewer components, or some components may be combined, or a different arrangement of components may be adopted.

The storage medium may further include an operating system and a network communication module. The operating system is a program that manages and stores hardware and software resources on a computer device and supports operations of the information processing program and other software and/or program. The network communication module is configured to enable communication between components within the storage medium, and with other hardware and software in the physical device.

By means of the description of the embodiments, a person skilled in the art can clearly understand that the present disclosure can be realized by means of software and a necessary universal hardware platform, and can also be realized by means of hardware by inputting sample data into an artificial intelligence generated content detection model to obtain a hit probability of the sample data; matching a content evaluation system based on attribute information of the sample data, wherein the content evaluation system includes at least one preset evaluation index and an evaluation rule of the preset evaluation index; processing the sample data based on the evaluation rule to determine a test value of the sample data relative to at least one preset evaluation index; and performing a weighted calculation on the hit probability and the test value based on a target weight corresponding to the hit probability and the preset evaluation index, to obtain a quality score for the sample data. According to the embodiments of the present disclosure, the probability of sample data being AI generated is determined by the pre-trained AI-generated content detection model, so as to screen samples with high authenticity and low likelihood of being AI-generated. At the same time, the attribute information is used to match at least one preset evaluation index suitable for the sample data and the corresponding evaluation rule. The sample data are accordingly tested in accordance with the evaluation rule with respect to different preset evaluation indexes, and a test value of the sample data relative to at least one preset evaluation index is obtained. Finally, based on a target weight corresponding to the hit probability and the preset evaluation index, the weights of the hit probability and the test value are calculated in order to complete the quality scoring of the sample data. On one hand, by integrating an advanced AI-generated content detection technology and a content innovation evaluation strategy, a comprehensive and accurate evaluation of the training data is realized, which not only effectively filters out those AI-generated data that may mislead the model training, but also significantly improves the purity and credibility of the sample dataset, which enhances the authenticity and reliability of the training data and lays a solid foundation for the subsequent model training. On the other hand, the preset evaluation indexes and the evaluation rules are adjusted and matched dynamically through the attribute information of the sample data, which has a high degree of flexibility, realizes multidimensional and high-precision evaluation of the training data, and covers key aspects, such as data integrity, accuracy, diversity, and innovativeness. The present disclosure satisfies different task requirements, and improves the generalization capability of the model trained based on the sample data and its ability to adapt to unknown data. The effort of redeveloping the model after introducing a new evaluation rule is saved, and the operational cost and difficulty of data quality assessment are reduced.

It will be understood by those skilled in the art that the drawings are only schematic diagrams of a preferred implementation scenario, and modules or processes in the drawings are not necessarily required for implementing the present disclosure. Those skilled in the art may understand that the modules in the apparatus in the implementation scenario may be distributed in the apparatus in the implementation scenario according to the implementation scenario, and may also be correspondingly changed to be located in one or more apparatuses different from the apparatus in the implementation scenario. The modules in the foregoing implementation scenario may be combined into one module, and may also be further split into a plurality of submodules.

The serial numbers of the embodiments of the disclosure are only for description, and do not indicate any preference among the implementation scenarios. The embodiments disclosed above are only several specific implementation scenarios of the disclosure. However, the present disclosure is not limited thereto, and any change conceivable by a person skilled in the art should fall within the scope of protection of the present disclosure.

What is claimed is:

1. A method for evaluating the quality of model samples, comprising:
inputting sample data into an AI-generated content detection model to obtain a hit probability of the sample data;
matching content evaluation system based on attribute information of the sample data, wherein the content evaluation system comprises at least one preset evaluation criterion and its corresponding evaluation rules;
processing the sample data based on the evaluation rule to determine a test value of the sample data relative to the at least one preset evaluation index; and
performing a weighted calculation on the hit probability and the test value based on a target weight corresponding to the hit probability and the preset evaluation criterion, to obtain a quality score for the sample data.

2. The method for evaluating the quality of a model sample according to claim 1, further comprising:
in a case that the data type of the sample data is text, obtaining pre-stored data whose attribute information is in the same range as that of the sample data, wherein the quality score of the pre-stored data is greater than a predefined score threshold;
determining a feature similarity between the sample data and the pre-stored data by using a text similarity algorithm; and
in a case that the feature similarity is greater than a first similarity threshold, cancelling the processing of the sample data based on the evaluation rule, and using the test value of the pre-stored data as the test value for the sample data.

3. The method for evaluating the quality of model samples according to claim 1, further comprising:
obtaining manually created data of a target theme as positive samples;
inputting the target theme into an artificial intelligence model to obtain AI-produced data of the target theme as negative samples;
dividing the positive samples and the negative samples into a training set and a validation set, wherein the difference in the number of positive samples and negative samples in the training set is less than a predefined threshold;
training a classification model based on the training set to obtain a candidate model;
inputting the validation set into the candidate model to obtain a predicted probability of the validation set;
in a case that the predicted probability of the positive samples in the validation set is less than a first preset probability, and the predicted probability of the negative sample in the validation set is greater than a second preset probability, confirming the candidate model as the artificial intelligence generated content detection model;
in a case that the predicted probability of the positive samples in the validation set is greater than or equal to the first preset probability, or the predicted probability of the negative sample in the validation set is less than or equal to the second preset probability, sending the positive samples or the negative samples in the validation set to a review node; and
training the candidate model based on a target feature fed back by the review node, to obtain the artificial intelligence generated content detection model.

4. The method for evaluating the quality of a model sample according to claim 1, further comprising:
training a target large model based on the sample data with the quality score greater than the score threshold;
inputting test data into the target large model to obtain prediction data;
comparing the predictions with the ground truth associated with the test data to determine the accuracy of the target large model;
in a case that the accuracy is less than an accuracy threshold, adjusting the target weight based on the accuracy; and
in a case that the accuracy is greater than or equal to the accuracy threshold, outputting the target large model.

5. The method for evaluating the quality of a model sample according to claim 1, further comprising:
performing an integrity check on the sample data; and
in a case that the input part or the output part of the sample data is missing, deleting the sample data, or supplementing the missing input part or the missed output part of the sample data based on the existing input part or the existing output part of the sample data.

6. The method for evaluating the quality of a model sample according to claim 1, characterized in that,
the attribute information comprises at least one of the following: data application scenario, data type, data format, word count, and memory usage;
the preset evaluation criteria comprises at least one of: grammar correctness, vocabulary diversity, presence of watermarks in images or videos, content richness, content coherence, and noise ratio.

7. The method for evaluating the quality of model samples according to claim 6, characterized in that, the data type of the sample data is text, and the preset evaluation criteria comprises content richness, the processing the sample data based on the evaluation rule comprises:
Tokenizing the sample data to identify multiple tokens within the data;
determining semantic similarity between different tokens in the sample data by using a natural language processing algorithm;
grouping different tokens with the semantic similarity greater than a second similarity threshold into similar tokens sets;
Calculating token frequencies of the similar token sets, the number of similar token sets, and the total word count of the sample data;
Establishing a comparative relationship among the token frequency range, the number range and content richness based on the word count of the sample data; and
comparing the token frequencies with the token frequency range of the similar vocabulary sets, and the number with the number range of the similar token sets, respectively, based on the comparison relationship, to determine the content richness corresponding to the token frequencies of the similar token sets and the number of the similar token sets.

8. An apparatus for evaluating the quality of a model sample, comprising:
a first detection module, configured to input sample data into an artificial intelligence generated content detection model to obtain a hit probability of the sample data;
a matching module, configured to match a content evaluation system based on attribute information of the sample data, wherein the content evaluation system comprises at least one preset evaluation index and an evaluation rule of the preset evaluation index;
a second detection module, configured to process the sample data based on the evaluation rule to determine a test value of the sample data relative to the at least one preset evaluation index; and
an evaluation module, configured to perform a weighted calculation on the hit probability and the test value based on a target weight corresponding to the hit probability and the preset evaluation index to obtain a quality score of the sample data.

9. A readable storage medium having programs or instructions stored thereon, wherein the programs or instructions, when executed by a processor, perform the steps of the method for evaluating the quality of a model sample according to claim 1.

10. A computer device, comprising: a storage medium; a processor; and a computer program stored on the storage medium and executable by the processor, wherein the processor, when executing the program, implements the method for evaluating the quality of model samples as described in claim 1.
